(19) United States
(12) Patent Application Publication
(10) Pub. No.: US 2004/0045444 A1
(43) Pub. Date: Mar. 11, 2004

(54) CORN POPPER HOPPER APPARATUS

(76) Inventor: Gary A. Mann, Cody, WY (US)

Correspondence Address: Charles I. Brodsky, 2 Bucks Lane, Marlboro, NJ, 07746, US

(21) Appl. No.: 10/237,119

(22) Filed: Sep. 9, 2002

(51) Int. Cl. A23L 1/18

(52) U.S. Cl. 99/323.5

(57) ABSTRACT

An enclosed hopper receives popped kettle corn input when in a substantially horizontal position supported atop a frame and, once moved to a dispensing location, is rotated to a vertical position substantially perpendicular to the frame, where hingeably coupled spouts are openable to effectuate the dropping of the popped kettle corn into a dispensing bag by gravity.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the preparation of a popped corn snack food popularly referred to as “kettle corn”, in general, and to the commercial vending of kettle corn, in particular.

2. Description of the Related Art

My two U.S. Pat. Nos. 5,857,403 and 6,032,572 describe a kettle corn popping structure especially useful by kettle corn vendors at such outdoor events as pioneer festivals, community commemorative events, fairs, markets, exhibitions of antiquated crafts and varieties of outdoor sports events. The corn popping apparatus there described structurally included a large popping kettle, a kettle support cabinet and a popped corn receiving-holding receptacle operable to permit the commercial vendor to prepare the popped corn, to dump the contents of its kettle into a suitable receptacle disposed outside the cabinet, and to be able to move the cabinet from one popping site to another with a substantial degree of mobility for such a relatively heavy structural combination. An improved process was also set forth to allow for producing and vending large quantities of the freshly prepared popped corn, while reducing to a minimum the hazards and discomforts which previously unavoidably attended the preparation of popped corn over an open flame. The structure set out enabled the preparer to tilt the popping kettle for dumping its contents very quickly and with very little physical effort, in a manner which was practical and efficient in its use and operation, while at the same time being of a simple yet rugged construction, which could be manufactured at reasonably low cost. With the attendant savings being thus able to be passed on to a purchasing consumer, there typically began being formed long lines of the buying public to purchase the popped kettle corn at these outdoor events.

As will be understood, to best serve these customers, a vendor needs to be able to dispense the popped kettle corn quickly and easily from the outside receptacle in which the contents of the kettle is dumped. Obviously, a large enough receptacle to accommodate all those purchasers which line up is essential; not so obvious is the further requirement that such receptacle needs to be readily movable from place to place and—while having to be highly stable once in position, must also be assemblable in easy manner for transportation to the next recurring event.

### SUMMARY OF THE INVENTION

As will become clear from the following description, the corn popper hopper apparatus of the present invention meets these needs—and, also, in a manner which allows for the easy dispensing of the popped kettle corn into the individual bags in which the popped corn is sold. As will be seen, the apparatus includes a roll-about support frame, along with an enclosed hopper having a first openable door to allow popped corn input to be added thereto and a second openable door to allow popped corn to be dispensed therefrom. Means is provided in this embodiment to couple an edge surface of the hopper to the frame, in a manner which allows an adjustment to rotate the hopper and the second openable door from a substantially horizontal position supported atop the frame to a vertical position substantially perpendicular to the frame. With the apparatus constructed in this manner, the coupling arrangement will be appreciated to be adjustable to rotate the hopper and the second openable door in the reverse direction, from the vertical position substantially perpendicular to the frame back to the horizontal position atop the frame. Thus, with the door opened with the hopper horizontal, popped corn from the receiving-holding kettle receptacle can be easily transferred by the vendor into the hopper, which, with its first door closed, then secures the popped corn in place; after rolling the support frame to the site where the popped corn is to be dispensed, the hopper is rotated to a substantially vertical position, such that the contents of the hopper falls by gravity toward the second door as a spout where the popped corn can be individually bagged and handed out. By having the coupling arrangement also adjustable to rotate the hopper and the second openable door from the substantially vertical position back to the horizontal position atop the frame, once the hopper is emptied, the apparatus can simply be rolled back to the receiving-holding kettle to be refilled, either manually, or by way of a vacuum pump and hose, for example.

To dispense the popped corn in the hopper even more quickly, a third openable door can be provided on its edge surface, spaced adjacent to the second openable door, to allow the popped corn to be bagged and handed over to a customer as from a second spout as well. While the apparatus of the invention performs quite satisfactorily with just a single discharge, a preferred embodiment includes the pair of spouts, defined by the second and third openable doors. In this embodiment, the first openable door through which the popped kettle corn is inputted from the receiving-holding receptacle is lockably closable in position in any appropriate manner, while the second and third openable doors are hingeably closable in position. By employing a pair of front facing wheels on the roll-about support frame, and a pair of rear facing wheels on the frame as well, the frame can easily be moved about from the corn popping area to the popped corn dispensing area. Ease of rolling is facilitated in this embodiment by having the rear facing wheels set to rotate in a fixed vertical plane, with the front facing wheels being adjustable to rotate in vertical planes movable from side-to-side, as an assist in directing the frame and supported hopper—a feature which is especially useful in moving the apparatus about over the uneven grounds typically found at outdoor events where the dispensing of popped kettle corn is especially welcome.

As will also be seen from the following description, a pair of springs are employed to assist the adjustment of the hopper to its substantially horizontal and substantially vertical positions, respectively. In the preferred embodiment described, the springs are arranged to a stretched condition in adjusting the hopper horizontally, and to a compressed condition in adjusting the hopper vertically; once adjusted vertically so as to dispense the inputted popped corn, the hopper is locked in place, to be released by a foot actuated control coupled with the frame once emptied, and then wheeled back to be refilled, lying horizontally.

With the corn popper hopper apparatus of the invention, then, easy filling of the hopper with popped kettle corn follows with the hopper horizontal and its first door opened, then with the first door closed, the hopper is moved to the desired location, where it is rotated to a substantially vertical position so that the popped kettle corn can be dispensed by bagging it through its hinged second (and third) doors when in place at its destination at the fairgrounds or other outdoor location. With the invention at hand, and in an actual construction, the hopper can easily hold 4-5 times the amount of popped kettle corn delivered to the typical receiving-holding kettle, and with its hingeably openable doors serving as spouts, is able to fill individual bags of popped kettle corn in approximately 3 seconds, as compared with the 30 seconds or so it normally takes to fill a bag with conventional apparatus. A significant increase in the speed of bagging thus follows, satisfying the long lines of buyers forming to purchase the popped kettle corn at outdoor events.

### BRIEF DESCRIPTION OF THE DRAWINGS

These and other features of the present invention will be more clearly understood from a consideration of the following description, taken in connection with the accompanying drawings, in which:

FIG. 1 is an illustrative view of the corn popper hopper apparatus of the invention as it would appear filled with popped kettle corn ready to be dispensed;

FIG. 2 shows the corn popper hopper apparatus as it would appear ready to be filled with the popped corn from the receiving-holding kettle receptacle;

FIG. 3 is helpful in an understanding of the manner by which the popped kettle corn is dispensed into a bag; and

FIGS. 4-6 are helpful in an understanding of the manner by which the preferred embodiment of corn popper hopper apparatus is locked and unlocked between the positions shown in FIGS. 1 and 2.

### DETAILED DESCRIPTION OF THE INVENTION

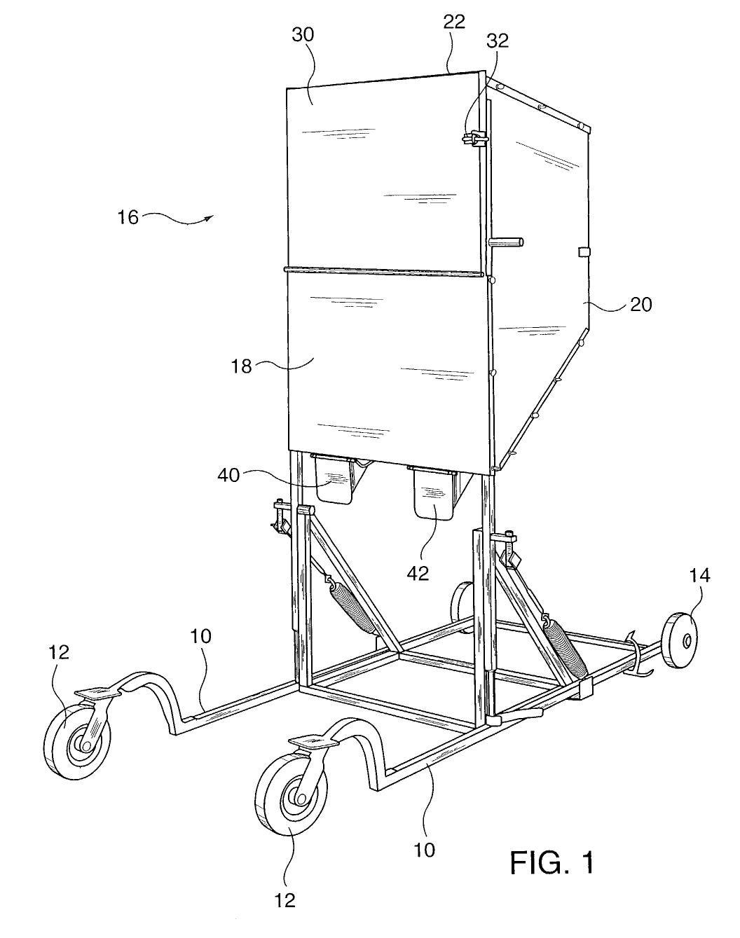

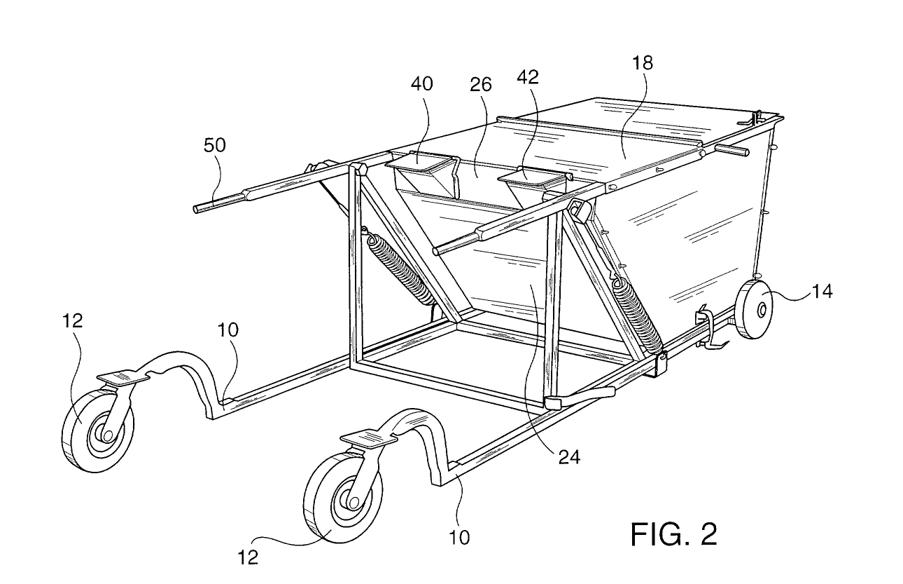

Referring to FIGS. 1-3, the corn popper hopper apparatus includes a roll-about support frame 10 having a pair of front facing wheels 12 and a pair of rear facing wheels 14. As shown, the wheels 14 are set to rotate in a fixed vertical plane, while the wheels 12 are adjustable to rotate in vertical planes movable from side-to-side to assist in moving the frame 10 about. A hopper 16 is shown coupled with the frame 10 generally substantially perpendicular to it as shown in FIG. 1, and substantially horizontal to, and supported by, the frame 10 in FIG. 2.

The hopper 16 is an enclosed unit having front, rear, top and bottom surfaces 18, 20, 22, 24, along with an edge surface 26 joining the front and bottom surfaces 18, 24. A first openable door 30 is provided in the front surface 18, which is lockably closable and openable by means of a bolt 32 or other arrangement in typical manner. Sliding the bolt 32 open with the hopper 16 in a substantially horizontal position, supported by the frame 10 (FIG. 2) allows opening of the door 30 to add the popped corn into the hopper from the receiving-holding kettle, as in the construction of my two previously noted Patents. Rotating the hopper 16 then to a vertical position substantially perpendicular to the frame 10 (as in FIG. 1), allows the inputted popped kettle corn to slide toward the edge surface 26, helped along by providing the bottom surface 24 with an angular close, as illustrated.

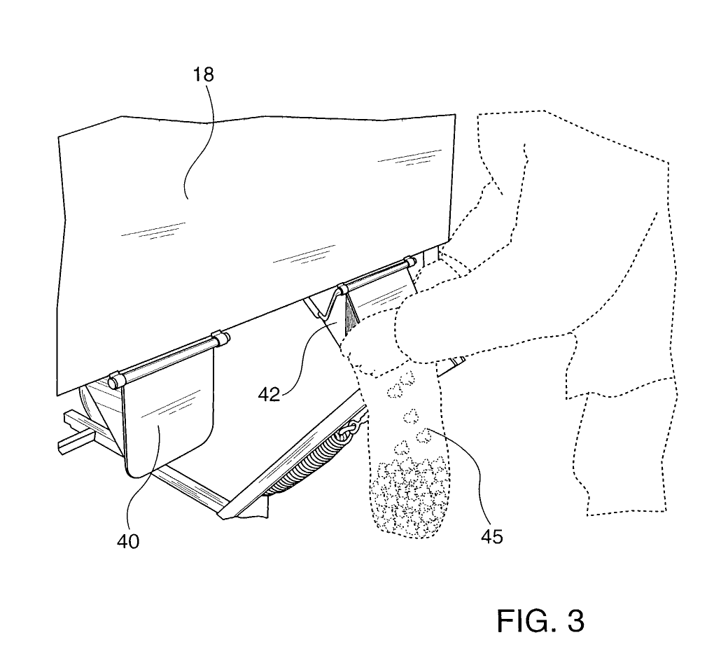

FIGS. 1 and 3 show the hopper 16 as having a second openable door 40 (and, where desired, a third openable door 42) serving as spouts through which the popped kettle corn can be dispensed and then bagged, as at 45. As more clearly shown in FIG. 3, such second and third doors are hingeably closed in position, in forming a pair of dispensing spouts for the hopper apparatus. In this manner, once the bag is placed in position with the resulting spout, lifting the door upwardly allows the stored popped corn to fall by gravity into the bag. Once empty, the hopper 16 of FIGS. 1 and 3 is returned to the position shown in FIG. 2, the door 30 is closed, and the hopper is wheeled back to the receiving-holding kettle for refilling.

FIGS. 1-3 illustrate the openable doors 40 and 42 as being spaced adjacent one another on the edge surface 26. There locations may be changed according to the invention, as can their manners of opening and closing in forming the dispensing spouts for the popped kettle corn.

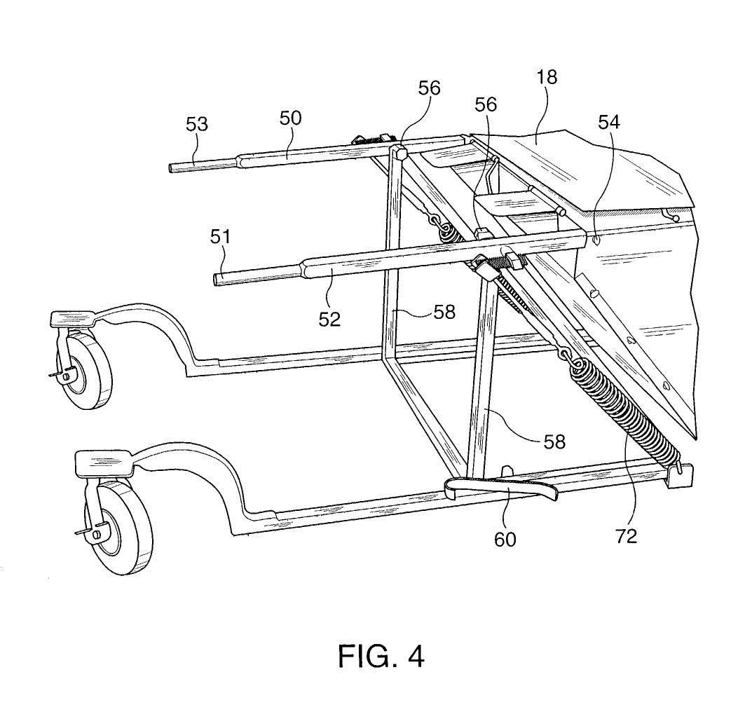

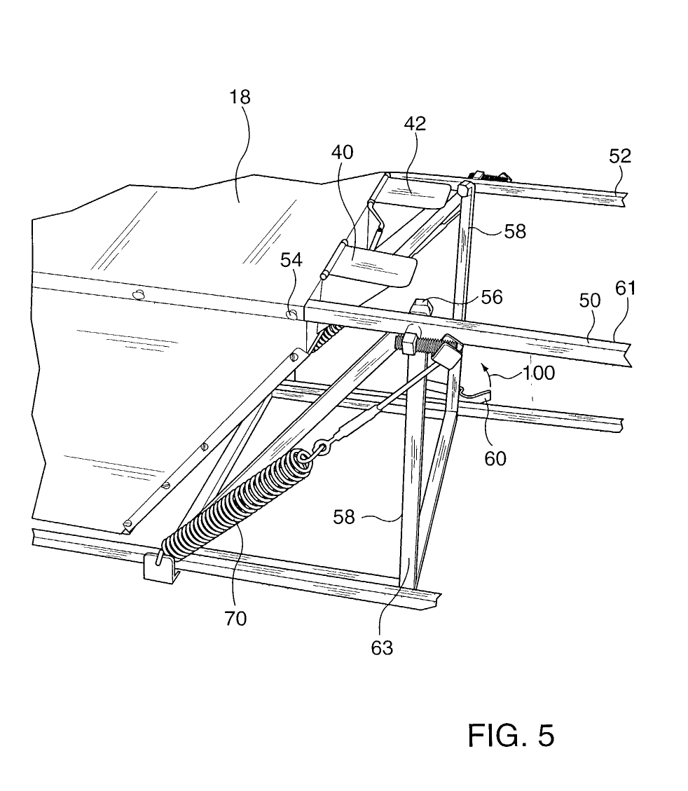

FIGS. 4-6 are helpful in an understanding of the manner by which the hopper 16 is adjustably rotated to lie horizontally atop the support frame 10 when the apparatus is moved about and to stand vertical, substantially perpendicular to the frame 10, when in position for dispensing. Specifically, a pair of legs 50, 52 extend perpendicularly outward from the edge surface 26, secured thereto as by bolts 54, and coupled to rotate about a pivot 56 through a leg 58 extending from the support frame 10. As more clearly shown in FIG. 4, one such pivot 56 and leg 58 are coupled at opposite sides of the frame 10; and a clip 60 is welded or otherwise formed on at least one side of the frame, at the end of the leg 58 remote from the pivot 56. Rotating the hopper 16 upwardly about the pivots 56 in a counterclockwise direction from the position shown in FIG. 4 raises the hopper 16 from the substantially horizontal position supported atop the frame 10 toward a substantially vertical position with respect to the frame. This rotation effectively moves the end 51 of the leg 52 under the clip 60, where it is held in place by the spring action of the clip 60—and moves the end 53 of the leg 50 toward the frame 10, as well. Such locking-in-place to then take on the appearance of FIG. 1 can more easily be understood from reference to FIG. 5, in which the inside surfaces 61 of the rotating legs 50, 52 swing adjacent the outside surface 63 of the legs 58. Also, clip 60 serves as a foot actuated release, by moving the clip 60 in the direction of the arrow 100 in FIG. 5, releasing its securement and allowing the hopper to be rotated downwardly clockwise back to the position of FIG. 4.

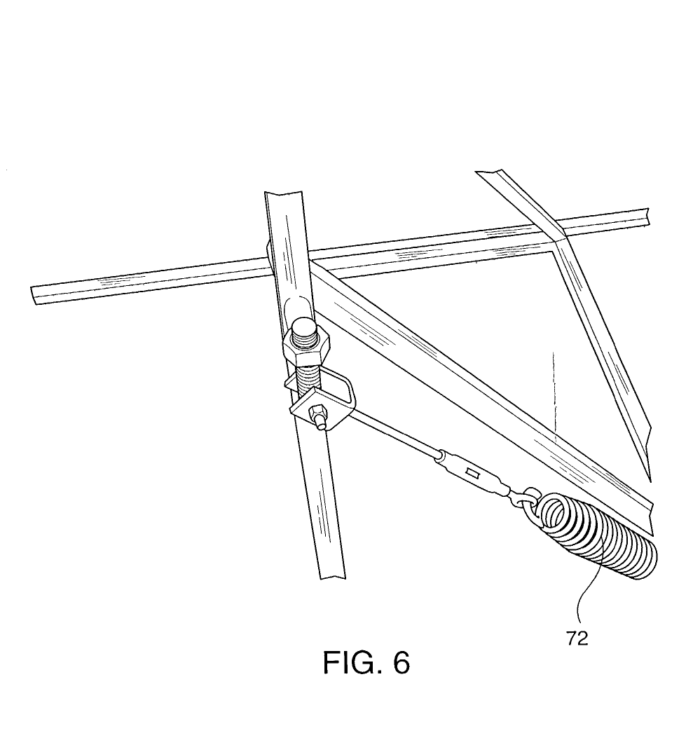

A pair of springs 70, 72 are also included in coupling to the pivot point 56 and to the support frame 10 as shown in FIGS. 1-2 and 4-5, stretchable to adjust the hopper 16 to the substantially horizontal position of FIGS. 2 and 5, and compressible to adjust the hopper 16 to the substantially vertical position of FIGS. 1 and 3. FIG. 6 illustrates the securement of the springs to the area of the join with the extension legs 50 and 52. As will be appreciated, the stretching and compression of the springs 70, 72 ease the rotation of the hopper 16 between its horizontal position for filling with popped kettle corn and for moving the corn popper hopper apparatus about, on the one hand, and its vertical position for dispensing its contents through the spouts 40, 42 when bagging.

As will be understood, the end result then becomes one by which the popper hopper 16 is easily filled with large amounts of the popped kettle corn, to be then rolled into position and rotated vertically for dispensing. While the filling of the hopper by the commercial vendor could be by hand, manually using scoops of appropriate size in conventional manner, a preferred way of doing so according to the invention is through the use of a vacuum pump and hose sucking up the kernels of popped corn and directing them through the hose into the open hopper. With either arrangement, however, the filling of the hopper is enhanced, as is the dispensing of the bagged product to the buyer.

Whereas there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the invention.

I claim:

1. A popped corn dispensing apparatus comprising:
a roll-about support frame;
an enclosed hopper having a first openable door to allow popped corn input thereto and a second openable door to allow popped corn output therefrom;
and means coupling an edge surface of said hopper to said frame;
with said means being adjustable to rotate said hopper and said second openable door from a substantially horizontal position supported atop said frame to a vertical position substantially perpendicular to said frame.

2. The apparatus of claim 1 with said means also being adjustable to rotate said hopper and said second openable door from said vertical position substantially perpendicular to said frame to a substantially horizontal position atop said frame.

3. The apparatus of claim 1 wherein said hopper includes a third openable door to allow popped corn output therefrom, and wherein said means is adjustable to rotate said hopper, said second openable door and said third openable door from a substantially horizontal position supported atop said frame to a vertical position substantially perpendicular to said frame, and wherein said means is further adjustable to rotate said hopper, said second openable door and said third openable door from said vertical position substantially perpendicular to said frame to a substantially horizontal position atop said frame.

4. The apparatus of claim 2 wherein said means includes a pair of springs stretchable to adjust said hopper to said substantially horizontal position, and compressible to adjust said hopper to said substantially vertical positions.

5. The apparatus of claim 2 wherein said means is lockable to a fixed position once adjusted to rotate said hopper and said second openable door from said substantially horizontal position to said substantially vertical position.

6. The apparatus of claim 5 wherein said means is unlockable from said fixed position by a foot actuated release coupled with said frame.

7. The apparatus of claim 1 wherein said support frame includes a pair of front facing wheels and a pair of rear facing wheels for rolling said frame about.

8. The apparatus of claim 7 wherein said pair of rear facing wheels are set to rotate in a fixed vertical plane, and wherein said pair of front facing wheels are adjusted to rotate in vertical planes movable from side-to-side.

9. The apparatus of claim 2 wherein said enclosed hopper includes front, rear, top and bottom surfaces, wherein said first openable door is incorporated within said front surface, and wherein said second openable door is incorporated in an edge surface joining said front and bottom surfaces together.

10. The apparatus of claim 3 wherein said enclosed hopper includes front, rear, top and bottom surfaces, wherein said first openable door is incorporated within said front surface, and wherein said second and third openable doors are incorporated in an edge surface joining said front and bottom surfaces together.

11. The apparatus of claim 10 wherein said second and third openable doors are spaced adjacent one another on said edge surface.

12. The apparatus of claim 9 wherein said first openable door is lockably closable in position, and wherein said second openable door is hingeably closable in position.

13. The apparatus of claim 10 wherein said first openable door is lockably closable in position, and wherein said second and third openable doors are hingeably closable in position.

14. The apparatus of claim 12 wherein said first openable door extends substantially along one half the length of said front surface, measured from said top surface to said edge surface.

15. A popped corn dispensing apparatus comprising:
a roll-about support frame;
an enclosed hopper having a first openable door to allow popped corn input thereto and a second openable door to allow popped corn output therefrom;
and means coupling an edge surface of said hopper to said frame;
with said means being adjustable to rotate said hopper, said first openable door and said second openable door from a substantially horizontal position supported atop said frame to a vertical position substantially perpendicular to said frame.

16. The apparatus of claim 15 with said means also being adjustable to rotate said hopper, said first openable door and said second openable door from said vertical position substantially perpendicular to said frame to a substantially horizontal position atop said frame.

17. The apparatus of claim 15 wherein said hopper includes a third openable door to allow popped corn output therefrom, and wherein said second means is adjustable to rotate said hopper, said first openable door, said second openable door and said third openable door from a substantially horizontal position supported atop said frame to a vertical position substantially perpendicular to said frame, and wherein said means is further adjustable to rotate said hopper, said first openable door, said second openable door and said third openable door from said vertical position substantially perpendicular to said frame to a substantially horizontal position atop said frame.

18. The apparatus of claim 16 wherein said means includes a pair of springs stretchable to adjust said hopper to a substantially horizontal position, and compressible to adjust said hopper to a substantially vertical position.

19. The apparatus of claim 16 wherein said means is lockable to a fixed position once adjusted to.

20. The apparatus of claim 19 wherein said means is unlockable from said fixed position by a foot actuated release coupled with said frame.
